(19) United States
(12) Patent Application Publication
(10) Pub. No.: US 2010/0164717 A1
(43) Pub. Date: Jul. 1, 2010

(54) FEILD DEVICE

(75) Inventors: Manfred Hammer, Wehr (DE); Herbert Schroth, Schopfheim (DE); Dietmar Spanke, Steinen (DE)

Correspondence Address: BACON & THOMAS, PLLC, 625 SLATERS LANE, FOURTH FLOOR, ALEXANDRIA, VA, 22314-1176, US

(73) Assignee: Endress + Hauser Gmbh + Co. KG, Maulburg (DE)

(21) Appl. No.: 12/451,738

(22) PCT Filed: Jun. 4, 2008
(86) PCT No.: PCT/EP2008/056877

§ 371 Date: Nov. 30, 2009

(30) Foreign Application Priority Data
Jun. 4, 2007 (DE) 10 2007 026 244.4

(51) Int. Cl. G08B 21/00

(52) U.S. Cl. 340/540

(57) ABSTRACT

A field device, wherein only those faults are displayed, which are relevant for the particular application of the user. The field device includes: a means for detecting a plurality of field-device-specific faults and for generating associated field-device-specific fault reports; a memory for storing an application-specific fault report profile, which contains exclusively those field-device-specific faults, which are relevant for a particular application; an interface, via which a user provides the fault report profile and stores such in memory; and a means for output of fault reports, which exclusively outputs fault reports of faults contained in the fault report profile.

### FIELD DEVICE

The invention relates to a field device having a means for detecting a plurality of field-device-specific faults and for generating associated field-device-specific fault reports, and to a means for output of fault reports.

In industrial measurements technology, especially in automation and process control technology, field devices are regularly applied, which, in the course of a process, measure (sensors) process variables or control (actuators) control variables.

Field devices include measuring devices measuring e.g. flow, fill level, pressure, pressure difference and/or temperature. They are, as a rule, arranged decentrally, in the immediate vicinity of the process component to be measured or controlled, and deliver a measurement signal corresponding to the measured value of the registered process variable. The measuring signals of the field devices are forwarded to a superordinated unit, e.g. a central, control unit, such as e.g. a control room or a process control system. As a rule, the entire process control occurs via the superordinated unit, which receives and evaluates the measuring signals of the individual measuring devices and, as a function of their evaluation, produces control signals for the actuators, which control the process flow. In this way, for example, flow through a pipeline section can be tuned by means of a controllable valve as a function of a measured flow.

A faultless and frictionless working of the field devices is of great importance for the safety of the applications, in which they are applied. Correspondingly, the functional ability of field devices is exactly monitored and occurring faults are displayed in the form of fault reports, e.g. as a warning or an alarm. Preferably, the field device monitors itself. Thus, the field device performs a self monitoring and/or diagnosis. For this, field devices are regularly equipped with means for detecting a plurality of field-device-specific faults and for generating associated field-device-specific fault reports. This monitors a plurality of field-device-specific variables and detects, on the basis of these variables, whether a fault is present. If the field device has a detected fault, then this is displayed by means of a corresponding output apparatus.

A large number of faults can be detected and/or inferred by the field devices. The number of these faults rises continually. A cause for this is improved signal analysis and storage opportunities, as well as the markedly increased computing power of today's field devices. Associated with this are improvements especially in the region of diagnosis and expanded diagnosis, by which always more faults can be detected and/or inferred. Such is, in principle, desirable, since a high measure of safety and reliability can be achieved thereby.

Typically, in a concrete application, in which the field device is being used, only a portion of the available fault reports are relevant. The others, in contrast, have no meaning for the particular application. The intersection of fault reports relevant in all applications is, on the basis of experience, small. Which fault reports are lastly relevant, depends in such case very strongly on the application, in which the field device is being used. For example, in the case of fill level measuring devices working with ultrasound, it is possible, on the basis of the attenuation of the sound waves, to determine, whether foam is on the surface of the fill substance. In some applications, foam formation is an important event that necessarily must be detected, in order to provide the user with the opportunity of executing a safety directed maneuver. In other applications, foam on the surface of the fill substance is, in contrast, normal. While the corresponding fault report is very important for the one user, it is irrelevant for the other user.

Due to the large number of detectable faults, there is the danger, that the user will, during operation, be overwhelmed by a large number of fault reports not relevant for the application. The user is quasi compelled by the multiplicity of the fault reports to sort those out, which are actually of meaning for the application. This introduces the danger, that relevant fault reports will be overlooked.

There are, today, already field devices on the market, in the case of which the user has the opportunity to exclude individual fault reports, which the factory already knows can be problematic. For example, for fill-level measuring devices, in the case of which the travel time of an electrical signal along a probe in a container is measured, it is checked, on the basis of the echo signal, whether the probe is broken off. Yet, some of these probes give the user the opportunity of shortening the probe to a desired length. The device would continually interpret a shortened probe as a broken probe and issue a corresponding fault report. Therefore, manufacturers offer the user, in this case, the opportunity of suppressing this particular fault report.

In the case of the most faults, however, the manufacturer does not know whether these lastly are relevant for the user or not. There is, consequently, the problem, that as many faults as possible must be detected and displayed by fault reports, in order to assure a high measure of safety in all applications, in which the device is used. On the other hand, it is certainly valid to avoid that the user is overwhelmed by irrelevant fault reports. In selecting the faults, which should be displayed, there is, in such case, always the danger that, under the circumstances of an application, safety-relevant fault reports might not be displayed.

It is an object of the invention to provide a field device and a method for handling of its faults, wherein only those faults are displayed, which are relevant for the particular application of the user.

To this end, the invention resides in a field device having
a means for detecting a plurality of field-device-specific faults and for generating associated field-device-specific fault reports,
a memory, for storing an application-specific fault report profile, which exclusively contains those field-device-specific faults, which are relevant for a certain application,
an interface,
via which a user provides the fault report profile and stores such in memory, and
a means for output of fault reports, which exclusively outputs fault reports of faults contained in the fault report profile.

In a further development of the invention, a memory is provided, in which there is associated with each fault contained in the fault report profile an evaluation, which is predetermined by the user and which the means for output of fault reports of the faults contained in the fault report profile outputs as a component of the relevant fault report.

In an embodiment, the evaluation is a status report,
which reports a failure of the field device or a portion thereof,
which reports that the output signal is temporarily incorrect,
which reports that the field device is operating outside of its specification, or
which reports a need for maintenance.

In a further development of the invention, a memory is provided, in which at least one prefabricated profile portion is stored, which contains a predefined set of faults. The memory is accessible via the interface, and the user can incorporate such profile portion into the fault report profile of the user.

In an embodiment, the interface comprises, directly arranged on the field device, a user interface having a display and an input means.

In a further development, a fault report profile created by the user is capable of being read out of the memory via the interface and can be transferred to an external data carrier or to an equally constructed field device.

In an additional further development, profile portions are loadable via the interface into the field device and storable there in memory.

Additionally, the invention resides in a method for creation and use of an application-specific fault report profile for a field device,
which has a means for detecting a plurality of field-device-specific faults and for generating associated field-device-specific fault reports, and
which has an interface, via which a user defines a fault report profile specific for the application
by selecting, from the plurality of field-device-specific fault reports, faults relevant for the application and storing such in a fault report profile specific for the application, and
the field device subsequently exclusively outputs fault reports of faults contained in the fault report profile.

Additionally, the invention resides in a method for creation and use of an application-specific fault report profile for a field device,
which has a means for detecting a plurality of field-device-specific faults and for generating associated field-device-specific fault reports,
wherein at least some of the faults are stored in at least one prefabricated profile portion, which contains a predefined set of faults, and
which has an interface, via which a user defines a fault report profile specific for the application,
by selecting from the plurality of field-device-specific fault reports, individually and/or via the selection of at least one prefabricated profile portion, fault reports relevant for the application, and storing such in a fault report profile specific for the particular application,
each first time occurring fault of this fault report profile is displayed,
the user determines during the first-time occurrence of a fault, whether such fault remains in the fault report profile or whether it is deleted from the fault report profile and subsequently no longer displayed, and
the field device subsequently outputs exclusively fault reports of the faults remaining in the fault report profile.

In a first embodiment of the first stated method, first, all field-device-specific faults are contained in the fault report profile. Each first time occurring fault is displayed, and the user ascertains during the first-time occurrence of a particular fault, whether such fault remains in the fault report profile or whether it is deleted from the fault report profile and subsequently no longer displayed.

In a further development of the first stated method, the user associates an evaluation with each fault contained in the fault profile. Such is stored in the field device, and, during the occurrence of a particular fault, output as a component of the fault report indicating the particular fault.

An advantage of the invention is that the field devices are, equipped with application-specific fault report profiles defined by the user, and the user is shown subsequently only the faults contained in such a fault report profile. The user can either manually individually earlier select the faults contained in the fault report profile or provide such to the field device during operation one after the other by correspondingly accepting first time occurring, fault reports. Alternatively or supplementally, the user can rely on predefined profile portions for this. In such case, the fact is utilized, that the knowledge concerning type and requirements of the application in which a field device is to be applied is knowledge that the user has.

Through the application of application-specific fault report profiles, it is assured, that exclusively displayed to the user are those faults, which are relevant for the particular application, in which the user desires to apply the device.

In such case, available to the user is the complete selection of all field-device-specific faults detectable by the field device. The user can utilize the complete bandwidth of detectable field-device-specific faults, without being inundated by, per se or for the application, unimportant fault reports.

The invention and other advantages thereof will now be explained in greater detail on the basis of the drawing, in which an example of an embodiment is presented. The sole FIGURE of the drawing shows as follows:

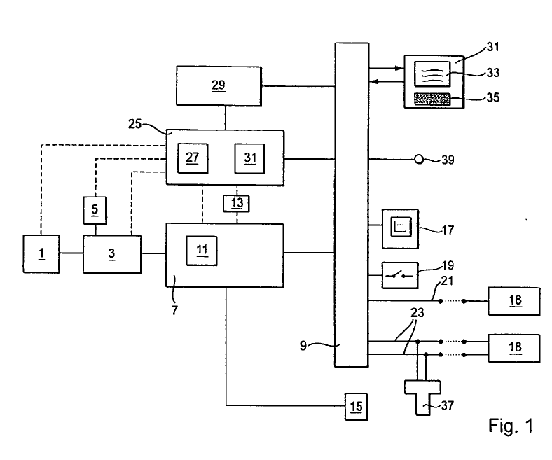

FIG. 1 a block diagram of a field device of the invention.

FIG. 1 shows a simplified block diagram of a field device of the invention. In the illustrated example of an embodiment, a measuring device is involved. The invention is, however, not limited to measuring devices. It is applicable in completely analogous manner also in other types of field devices, e.g. also in actuators.

The measuring device includes a sensor 1 for registering a physical, measured variable, e.g. a fill level, pressure or temperature, and producing a sensor signal corresponding to the physical, measured variable. Connected to the sensor 1 is a signal conditioning unit 3 for conditioning the sensor signal for further processing and/or evaluation. The signal conditioning unit 3 can include, for example, filtering, amplifying and/or digitizing of the sensor signal. Additionally, a compensation of measurement errors, such as e.g. a compensation of temperature dependent deviations, can be performed. For this, for example, parameters, characteristic curves and/or calibration data stored in a memory 5 can be taken into consideration.

The conditioned sensor signal is fed to a signal processing unit 7, which ascertains on the basis of the conditioned sensor signal the physical variable to be measured, and makes available a corresponding output signal via an output unit 9 of the field device.

The signal processing unit 7 includes preferably an electronic unit 11, e.g. a microprocessor, to which the conditioned sensor signal is fed.

The electronic unit 11 ascertains the variable to be measured, for example, on the basis of programs stored in a memory 13, taking into consideration, for example, likewise parameters, characteristic curves and/or calibration data stored in the field device, e.g. in the memories 5 and/or 13.

Additionally, the signal processing unit 7 can be fed other information for determining the physical variable. This information can be derived within the field device or fed via corresponding interfaces 15 from the outside. Examples of such information are additional measured variables or manipulated variables, which, for example, are derived internally in the field device, e.g. from additional sensors, or are fed via the interface 15 from the outside.

Field devices are commercially obtainable today in combination with a large number of different types of outputs. Some types are illustrated in FIG. 1, for example, and can be provided both along with one another as well as also alternatively relative to one another. The output unit 9 includes, for example, an on-site display 17, a relay 19, or connection lines 21, 23, via which the output signal is suppliable in analog or digital form to a superordinated unit 18, e.g. a programmable logic controller (PLC), a process control system (PLS) or a personal computer (PC).

The output of a digital output signal can, for example, occur via a data bus conductor, here the connection line 21, connected to the output unit 9. Known international standards for this type of signal transmission include Profibus, Foundation Fieldbus or CAN bus.

The output of analog output signals occurs very frequently via a line-pair, here the two connection lines 23, connected to the output unit 9. Via the line-pair, both the energy supply of the field device as well as also the output of the output signal occurs. These devices are frequently referred to as 2-wire devices. According to standard, such devices are fed with input voltages of 12 V up to a maximum of 36 V and the field device controls, as a function of an instantaneous measured value, an electrical current flowing via the line-pair. The output signal is, in the case of these field devices, a signal current. In a standard usual in measurements and control technology, the signal current is set, as a function of the instantaneous measured value, to values between a minimum signal current of 4 mA and a maximum signal current of 20 mA. Additionally, there can be superimposed on the signal current a communication signal, via which a bidirectional communication with the field device can occur. Also for this, there are standards, such as e.g. HART, usual in measurements and control technology.

The field device includes a means 25 for detecting a plurality of field-device-specific faults and for generating associated field-device-specific fault reports. A great number of such field-device-specific faults are listed in NAMUR-recommendation NE107: ‘Self Monitoring and Diagnosis of Field Devices’.

The means 25 can be a component of the signal processing unit 7. It can, however, also be embodied as an independent unit. Alternatively, naturally also a number of decentralized subunits can be arranged at functionally relevant locations in the field device and connected with one another. In the example of an embodiment illustrated in FIG. 1, it is represented as a separate unit. It includes a monitoring unit 27, e.g. a microprocessor, to which are continually fed all information and data required for the detecting the faults. Such is indicated symbolically in FIG. 1 by the dashed lines. The information and data comprise e.g. internally derived variables, such as e.g. form, amplitude or frequency of the sensor signal, input or output voltages of individual components of the field device, however, also predetermined parameters, such as e.g. desired values for individual characterizing variables, measuring ranges, threshold values, reference values, calibration data, or parameters predetermined by the user, e.g. in the context of start-up, such as e.g. data for the measuring location, e.g. a maximum permissible fill level in a container, or the position of stirrers in the container.

The monitoring unit 27 monitors the data and information supplied it continually and checks whether a fault is present. For this, a number of different methods are applicable. These range, depending on type of fault to be recognized, from simple comparison with a reference value, up to the execution of extremely complex, monitoring algorithms.

According to the invention, the field device includes a memory 29 which serves for storing an application specific, fault report profile. The application specific, fault report profile contains exclusively those field-device-specific faults, which are relevant for a certain application. In the field device, a means 31 for output of fault reports is provided, which outputs exclusively the fault reports for the faults contained in the fault report profile. The content of the application-specific fault report profile is defined by the user. For this, the field device includes an interface 31, via which the user provides the fault report profile and stores such in memory 29.

The actual fault report depends on the type of fault to be reported. Preferably, the fault report contains besides the name of the fault, e.g. ‘strong fluctuation of measurement signal amplitude’, also an evaluation of the fault. This evaluation serves preferably to indicate to the user the quality, meaning and/or safety relevance of the fault. An example of such an evaluation is a status report associated with the fault, such as described in the NAMUR-recommendation NE107: ‘Self Monitoring and Diagnosis of Field Devices’. Four different status reports are recommended, namely a first status report, which reports a failure of the field device or a portion thereof, a second status report, which reports that the output signal is temporarily incorrect, a third status report, which reports that the field device is operating outside of its specification, and a fourth status report, which reports a need for maintenance.

In the case of conventional field devices, there is associated at the factory with each fault an evaluation, which is output during the occurrence of the fault as a component of the fault report. Such, however, presents problems, since one and the same fault, such as already explained, can be evaluated differently in different applications.

The field device of the invention includes, consequently, preferably a memory in which there is associated with each fault contained in the fault report profile an evaluation selected by the user, which the means for output of the fault reports contained in the fault report profile then is able to output as a component of the fault report. In the illustrated example of an embodiment, memory 29 is used for this. Preferably, the evaluation is stored in memory 29 together with the particular fault in the fault report profile. These application-specific evaluations of the individual faults are selected by the user and stored via the interface 31 in memory 29. In such case, the user can either be given the opportunity, even to define the evaluation as regards content, or to select from preformulated evaluations, such as e.g. the four above listed status reports, that, which is best suited for the application.

Additionally, the fault report can be combined with a safety directed reaction of the field device to the occurrence of the particular fault and the reaction activated in the device by the corresponding fault report. For example, the field device can, during the occurrence of a fault, which brings about a failure of the device, output a predetermined safety directed signal, instead of the output signal representing the measurement result. In the case of the above mentioned, 2-wire devices, e.g. the signal current is controlled to a predetermined, measured value independent, value, e.g. 3.6 mA or 22 mA.

Interface 31 is, in the example of an embodiment illustrated in FIG. 1, a user interface arranged directly on the field device and includes a display 33 and an input means 35, e.g. a keypad. Interface 31 is connected to the output unit 9 and permits via the output unit 9 both a bidirectional communication with the field device, especially with the means 25, as well as also an accessing of the associated memory 29. Via this bidirectional connection, the user receives information needed for creation of the application-specific fault report profile and provides via this connection the application specific fault report profile.

Depending on embodiment of the field device, however, also other types of interfaces can be provided. Preferably used for this are interfaces, which the field device has available in any event.

In the case of field devices, in which the output unit 9 has available, outputs, which provide a bidirectional communication between the field device and the superordinated unit 18, the interface can, for example, be integrated into the superordinated unit 18. In any event, a user interface is regularly provided and includes a display and an input apparatus, via which the user communicates with the field device. The user receives, in this case, via the superordinated unit 18, the opportunity to select and to store a fault report profile specific for the application.

Alternatively suited as interface is a mobile operating, or servicing, tool 37, which is connectable to the connection lines 23 of the output unit 9 and communicates with the field device via a communication signal superimposed on the signal current.

The output of the fault report occurs preferably via the output unit 9. For this, the output unit 9 can have a separate output 39, via which the fault reports are output. It can, however, also be transmitted via the same output, via which also the measurement signal is transmitted, in that it is, for example, output via the bus line 21, or superimposed on the signal current in the connection lines 23 in the form of a communication signal.

In creating the application-specific fault report profile, procedure is such that the user selects via the interface 31, from the plurality of field-device-specific fault reports, the fault reports relevant for the application and stores such in a fault report profile specific for the particular application. The field device subsequently issues only fault reports still contained in the fault report profile. It suffices, when the field device subsequently only still monitors the occurrence of the faults contained in the fault report profile.

Selection of the faults and storing of the application-specific fault report profile can occur, for example, in the context of start-up of the field device. For this, the field device can be shifted into a setup mode, in which the field device displays to the user via the interface 31, one after the other, all detectable field-device-specific faults, and the user indicates via the interface 31, whether given faults are to be stored in the fault report profile or not. Additionally, the user can store, for each fault, which the user stores in the fault report profile, an associated evaluation, which is to be output as a component of the associated fault report during the occurrence of such fault. For this, the user can select an evaluation from a predetermined selection of different evaluations, for example, from the above cited status reports recommended by NAMUR, or the user can specify and store its own evaluation for the application, an evaluation better suited as regards content.

Alternatively, at delivery of the field device, first, all field-device-specific fault reports can be contained in the fault report profile. The field device displays to the user each first time arising fault by output of a factory predetermined fault report and the user selects during the first-time occurrence of a particular fault, whether such fault remains in the fault report profile or whether it is deleted from the fault report profile and subsequently no longer displayed. In this way, the field device learns step-wise the application-specific fault report profile, without the user having earlier to store all faults individually in the fault report profile. Also in the case of this method, the user can store, for each fault remaining in the fault report profile, an associated evaluation, which is then output upon the occurrence of a particular fault as a component of its fault report. For this, the user can select an evaluation from a predetermined selection of different evaluations, or the user can specify and store its own evaluation better suited for the application as regards content.

In order to facilitate for the user the defining and storing of the application-specific fault report profile of the user, there can be provided in the field device a memory, in which at least one prefabricated profile portion is stored, that contains a predefined set of faults. This memory, e.g. the memory 29, is accessible via the interface 31 and the user has the opportunity via the interface 31 to select desired profile portions and to incorporate the therein contained faults into the user's fault report profile.

An example of such a profile portion is e.g. a profile directed to operational safety, in which all faults are combined, which result in a failure of the field device.

A further example of such a profile portion is e.g. an industrial sector specific, standard profile, in which all faults usually relevant in a particular industrial sector, e.g. in the wastewater industrial sector, are combined.

These profile portions can be stored in the field device at the factory. Alternatively, they can, however, also be made available via other media, such as e.g. diskettes or via the Internet, and be downloaded and stored in field device via the interface 31.

Conversely, the user can, via the interface 31, read out from the memory 29 an application specific fault report profile created by the user and transfer such onto an external data carrier. This offers the advantage that a once created fault report profile can be transferred to other, equally constructed, field devices. There, it can be applied either as a profile portion, which is then expanded to a complete fault report profile, or it can be stored as a complete fault report profile.

Of course, by a corresponding selection, also application-specific fault report profiles can be created, which contain at least one profile portion and other faults detectable by the means 25. Furthermore, such a profile can subsequently be optimized. For this, for example, the following method for creation and application of an application-specific fault report profile in a field device is applied, which has a means 25 has for detecting a plurality of field-device-specific faults and for generating associated field-device-specific fault reports, wherein at least some of the faults are stored in at least one prefabricated profile portion containing a predefined set of faults. In this method, the user defines via the interface 31 a fault report profile specific for the application by selecting from the plurality of field-device-specific fault reports, individually and/or via the selection of at least one prefabricated profile portion, the relevant fault reports for the application and stores such in a fault report profile specific for the particular application. Subsequently, each first time occurring fault of this fault report profile is displayed. The optimizing occurs then by the user ascertaining during the first-time occurrence of a particular fault, whether such fault remains in the fault report profile or whether it is deleted from the fault report profile and subsequently no longer displayed. Thereafter, the field device issues exclusively the fault reports of the faults remaining in the fault report profile. In this way, the user has the opportunity subsequently to remove, from the initial selection of the user, those faults, which only later prove to be unnecessary or redundant.

TABLE 1

| Reference Character | Name |
|---|---|
| 1 | sensor |
| 3 | signal conditioning unit |
| 5 | memory |
| 7 | signal processing unit |
| 9 | output unit |
| 11 | electronic unit |
| 13 | memory |
| 15 | interface |
| 17 | on-site display |
| 19 | relay |
| 21 | connection line |
| 23 | connection line |
| 25 | means for detecting a plurality of |
| | field-device-specific faults and for |
| | generating associated field-device- |
| | specific fault reports |
| 27 | monitoring unit |
| 29 | memory |
| 31 | means for output of fault reports |
| 33 | display |
| 35 | input means |
| 37 | operating, or servicing, tool |
| 39 | output |

1-11. (canceled)

12. A field device, comprising:
a means for detecting a plurality of field-device-specific faults and for generating associated field-device-specific fault reports;
a memory for storing an application-specific fault report profile, which exclusively contains field-device-specific faults relevant for a certain application,
an interface, via which a user provides the fault report profile and stores such in said memory; and
means for output of fault reports, which exclusively outputs fault reports of faults contained in the fault report profile.

13. The field device as claimed in claim 12, wherein:
said memory, in which there is associated, with each fault contained in the fault report profile, an evaluation, which is predetermined by the user and which said means for output of fault reports contained in the fault report profile outputs as a component of the fault report for a fault.

14. The field device as claimed in claim 13, wherein:
the evaluation is a status report, which reports a failure of the field device or a portion thereof, which reports that the output signal is temporarily incorrect, which reports that the field device is operating outside of its specification, or which reports a need for maintenance.

15. The field device as claimed in claim 12, wherein:
said memory stores at least one prefabricated profile portion, which contains a predefined set of faults;
said memory is accessible via said interface; and
the user can incorporate each profile portion into a fault report profile of the user.

16. The field device as claimed in claim 12, wherein:
said interface comprises, directly arranged on the field device, a user interface having a display and an input means.

17. The field device as claimed in claim 12, wherein:
a fault report profile created by the user is, via said interface, capable of being read out from said memory and is transferable onto an external data carrier or an equally constructed field device.

18. The field device as claimed in claim 15, wherein:
profile portions are loadable via said interface into the field device and storable there in said memory.

19. A method for creation and use of an application-specific fault report profile for a field device which has means for detecting a plurality of field-device-specific faults and for generating associated field-device-specific fault reports, and which has an interface, via which a user defines a fault report profile specific for an application, the method comprising the steps of:
selecting, from the plurality of field-device-specific fault reports, fault reports relevant for the application and storing such in a fault report profile specific for the application; and
outputting fault reports of faults contained in the fault report profile exclusively by the field device.

20. A method for creation and use of an application-specific fault report profile for a field device which has a means for detecting a plurality of field-device-specific faults and for generating associated field-device-specific fault reports, wherein at least some of the faults are stored in at least one prefabricated profile portion that contains a predefined set of faults, and which has an interface, via which a user defines a fault report profile specific for an application, the method comprising the steps of:
selecting from the plurality of field-device-specific fault reports, individually and/or via the selection of at least one prefabricated profile portion, fault reports relevant for the application and storing such in a fault report profile specific for the application;
displaying each first time occurring fault of such fault report profile;
the user ascertaining during the first-time occurrence of a particular fault, whether such fault remains in the fault report profile or whether it is deleted from the fault report profile and subsequently no longer displayed; and
the field device subsequently outputs exclusively fault reports of faults remaining in the fault report profile.

21. The method as claimed in claim 19, wherein:
first, all field-device-specific fault reports are contained in the fault report profile;
each first time occurring fault is displayed; and
the user ascertains during the first-time occurrence of a particular fault, whether such fault remains in the fault report profile or whether it is deleted from the fault report profile and subsequently no longer displayed.

22. The method as claimed in claim 19, wherein:
the user associates, with each fault contained in the fault profile, an evaluation, which is stored in the field device, and which is output during occurrence of a particular fault as a component of the fault report indicating the particular fault.
